(19) United States
(12) Patent Application Publication
(10) Pub. No.: US 2024/0308881 A1
(43) Pub. Date: Sep. 19, 2024

(54) APPARATUS AND PROCESS FOR REDUCED ENERGY CAVITATION

(71) Applicant: AQUALOGIQ INC., Irvine, TX (US)

(72) Inventor: Harold E. Haney, Quebec (CA)

(73) Assignee: AQUALOGIQ INC., Irvine, TX (US)

(21) Appl. No.: 18/601,364

(22) Filed: Mar. 11, 2024

Related U.S. Application Data
(60) Provisional application No. 63/452,622, filed on Mar. 16, 2023.

(51) Int. Cl. C02F 1/34; C02F 1/00; C02F 101/30

(52) U.S. Cl. CPC C02F 1/34; C02F 1/008; C02F 2101/30; C02F 2201/002; C02F 2209/003; C02F 2209/40; C02F 2301/046

(57) ABSTRACT

An apparatus and process that exposes aqueous media to a first one or more rotors, and to a second one or more rotors, the second one or more rotors spaced from the first one or more rotors to define a static zone. The first one or more rotors, the static zone and the second one or more rotors may be enclosed within a treatment vessel and may be operated by a drive component capable of variable rotational velocities. Exposing the aqueous media to gas supersaturation under pressure results in the aqueous media becoming multiphase fluid and, due to non-water components, a complex, compressible, multiphase fluid exhibiting non-Newtonian fluid characteristics. An increased level of symmetric and asymmetric cavitation events, energies, and their effects are achieved, beyond those that can be attained by conventional low energy hydrodynamic cavitation systems.

### CROSS-REFERENCE TO RELATED APPLICATIONS

This application claim benefit of U.S. Provisional Application Ser. No. 63/452,622 filed Mar. 16, 2023 titled APPARATUS AND PROCESS FOR REDUCED ENERGY CAVITATION which is hereby incorporated by reference in its entirety.

### TECHNICAL FIELD

This disclosure is generally directed to the treatment of organic, organically complexed inorganic, and microbiologic constituents in aqueous media. More specifically, it relates to an apparatus and process for developing increased cavitation events, energies, and their effects in aqueous media used for the treatment of water and wastewater streams, sludges, and residuals.

### BACKGROUND

Modern industrial and municipal water treatment and wastewater treatment processes produce unnecessarily large and copious volumes of chemical, inorganic, organic, microbiological, and biologic liquid wastes, residuals, and sludges, as a consequence of their specific treatment method. Landfills, mines, chemical processors, abattoirs, and refining processes, create complex and highly toxic waste streams, residuals, sludges, solid wastes, and leachates. Feed water treatment of polluted fresh water, brackish water, seawater, and other highly saline source waters, prior to potabilization by thermal, vacuum, and membrane desalination processors, results in high volumes of chemically toxified liquids, sludges, and solid wastes. Depuration of high saline recirculating systems results in chemically, organically, and biologically contaminated liquid and sludge wastes.

Conventional treatment methods and processes for treating water, wastewater, and their residuals include mechanical, physical, chemical, biological, irradiation, oxidation, advanced oxidation, thermic, cogeneration, incineration, EDR anode-cathode ion extraction, ion-exchange, membrane separation, various means of cavitation, and other complex processes. These are often combined in order to produce usable water. These same methods are applied to waste discharges of these same treatment systems to reduce the final volumes of waste and to meet environmental, health, and safety guidelines for liquid discharge, handling and disposal as sludges, or disposal as solid wastes.

As applied for the treatment of residual wastes, these conventional methods are complex, expensive, and often not efficacious. At best, these result in significant volumes of even more highly concentrated liquid wastes, densified sludges, and semi-solid wastes. The disposal of these wastes, containing hazardous and toxic organic components, active microbial pathogens, persistent organic pollutants, biomedical wastes, and biologics, present specific challenges and represent the most problematic, complex, and, expensive, problems facing conventional water and wastewater treatment installations, equipment, and processes.

In recent years, special attention has been dedicated to environmentally friendly treatments of wastewater streams that do not require the use of external chemicals, or carbon-based fuels, and provide the reduction of high energy use in the treatment. One such process, which does not require the addition of externally introduced chemicals, carbon-based fuels sources, or thermally driven methods, is cavitation. Cavitation is the formation, growth, and subsequent collapse of vapor filled cavities and voids, that further develop into cavitation bubbles inside a fluid, generated by changes in the hydrostatic system, or hydrodynamic conditions of the fluid. When cavitation bubbles collapse, enormous energy that drives the physical processes connected with cavitation are released. Disintegration of any organic constituents or microorganisms suspended, dissolved, and carried in the fluid can be achieved by the physical effects as well as extreme temperatures localized to the vicinity of the cavitation event, high energy oxidation by free radicals formed as vapors trapped in cavitating bubbles dissociate, as well as interaction with photons generated by the cavitation event.

The changes in a fluid's condition that leads to cavitation events can be caused mechanically (e.g., using velocity-imparting components and wave dynamics, caused by mechanical devices, such as propellers and solids grinding blades); hydrodynamically (e.g. shear velocities caused by high pressures forcing liquids through nozzles or micro-channels), by shear stresses (e.g. high velocity fluid entering a near-static fluid zone, such as by a venturi device), by thermal energies (e.g. heating the fluid to near or above its vaporization point), or by bombardment with high-energy particles (e.g., alpha decay particles internal to or externally applied to the fluid, or by fast moving neutrons in nuclear power reactors) in the case of inertial cavitation; or, acoustically (e.g. ultrasound), or optically (e.g., using laser beams) in non-inertial cavitation.

While many different methods may be employed to cavitate a fluid, conventional methods currently available have shown to be of limited efficacy, or to require an excessive investment in equipment needing untenably high energy requirements, in order to meet proscribed treatment goals. The movement of large volumes of a fluid media at the requisite speed through constriction to effect hydrodynamic cavitation requires expensive installations and extremely large energy inputs. This parallels the equipment requirements and energy needed to create sufficient cavitation events, energies, and effects needed for ultrasonic and thermal cavitation systems and processes. Due to these factors, cavitation has not been adopted within water or wastewater treatment applications of any significant size, to date. As a result, achieving treatment of wastewater streams from conventional non-inertial, or hydrodynamic solutions employing currently known methods remain impractical, expensive, and damaging to the environment.

It is therefore an object of the present disclosure to provide an apparatus and process that develops an increased amount of cavitation events, energies and their effects in a given fluid flow at reduced energy input requirements to treat water, wastewater, residuals, and sludges.

### SUMMARY

This disclosure relates to an apparatus and process for developing increased cavitation events, energies, and their effects in aqueous media used for treatment of water and wastewater streams, sludges, and residuals at greatly reduced energy and equipment costs.

An apparatus is disclosed for treating an aqueous media having organic constituents and microorganisms by causing cavitation. The apparatus comprises a vessel having an inlet and an outlet, a first rotor and a second rotor. The second rotor is spaced from the first rotor to define a static zone between the first rotor and the second rotor and wherein a volume of the vessel between the first rotor and the second rotor comprises at least three times the volume displaced by the first rotor in one revolution. In an additional embodiment, the volume displaced by the second rotor in one revolution is greater than the volume displaced by the first rotor in one revolution.

A process is also disclosed for treating an aqueous media, which may contain organic constituents and microorganisms by causing cavitation in the aqueous media. The process comprising increasing a first velocity of the aqueous media in a first dynamic zone, decreasing a second velocity of the aqueous media in a static zone, and increasing a third velocity of the aqueous media in a second dynamic zone. The second dynamic zone and the static zone may be located downstream of the first dynamic zone. The first velocity may comprise non-linear acceleration. Moreover, the increase in the first velocity, in tandem with further forces, may result in an increase in angular momentum of components in the aqueous media. The process may further comprise increasing non-linear acceleration in the first dynamic zone and increasing the non-linear acceleration of the aqueous media in the second dynamic zone. The process may also comprise, causing non-uniform decreases in both velocity and momentum of the fluid component and de-fluidized components of the aqueous media in the static zone.

In some embodiments, the disclosed subject matter described herein relates to an apparatus for treating an aqueous media including organic constituents and microorganisms by causing cavitation in the aqueous media including: a vessel including an inlet and an outlet, a first rotor and a second rotor, the second rotor spaced from the first rotor to define a static zone between the first rotor and the second rotor.

In some embodiments, the disclosed subject matter described herein relates to an apparatus, wherein a first volume of the vessel between the first rotor and the second rotor includes at least three times a second volume displaced by the first rotor in one revolution.

In some embodiments, the disclosed subject matter described herein relates to an apparatus, wherein a third volume displaced by the second rotor in one revolution is greater than a second volume displaced by the first rotor in one revolution.

In some embodiments, the disclosed subject matter described herein relates to an apparatus, wherein the first rotor is preceded by a plurality of rotors together including a first rotor assembly.

In some embodiments, the disclosed subject matter described herein relates to an apparatus, wherein the second rotor is succeeded by a plurality of rotors together including a second rotor assembly.

In some embodiments, the disclosed subject matter described herein relates to an apparatus, wherein the static zone is defined by a wall of non-metallic material.

In some embodiments, the disclosed subject matter described herein relates to an apparatus, wherein the first rotor and/or the second rotor includes an impeller.

In some embodiments, the disclosed subject matter described herein relates to an apparatus, wherein the first rotor and/or the second rotor includes a turbine.

In some embodiments, the disclosed subject matter described herein relates to an apparatus, further including a sensor to detect a level of cavitation in the aqueous media and adjust a speed of the first rotor and/or the second rotor to a level of detection of cavitation in the aqueous media.

In some embodiments, the disclosed subject matter described herein relates to a process for treating an aqueous media including organic constituents and microorganisms by causing cavitation in the aqueous media including; increasing a first velocity of the aqueous media in a first dynamic zone; decreasing a second velocity of the aqueous media in a static zone; and increasing a third velocity of the aqueous media in a second dynamic zone.

In some embodiments, the disclosed subject matter described herein relates to a process, wherein an increase in the first velocity results in an increase in angular momentum of components in the aqueous media.

In some embodiments, the disclosed subject matter described herein relates to a process, wherein the second dynamic zone is downstream of the first dynamic zone.

In some embodiments, the disclosed subject matter described herein relates to a process, wherein the static zone is downstream of the first dynamic zone.

In some embodiments, the disclosed subject matter described herein relates to a process, further including increasing non-linear acceleration in the first dynamic zone.

In some embodiments, the disclosed subject matter described herein relates to a process, further including increasing the non-linear acceleration of the aqueous media in the second dynamic zone.

In some embodiments, the disclosed subject matter described herein relates to a process, further including revolving a rotor to impart angular momentum to components in the aqueous media.

In some embodiments, the disclosed subject matter described herein relates to a process, further including decreasing a non-linear acceleration of the aqueous media in the static zone.

In some embodiments, the disclosed subject matter described herein relates to a process, wherein a volumetric flow rate of the aqueous media through the static zone is no more than ⅓ of the volumetric flow rate through the first dynamic zone.

In some embodiments, the disclosed subject matter described herein relates to a process, further including feeding the aqueous media to an inlet to a vessel including the first dynamic zone, the static zone and the second dynamic zone and discharging treated aqueous media from an outlet from the vessel.

In some embodiments, the disclosed subject matter described herein relates to a process, further including recycling treated aqueous media to the inlet of the vessel.

In some embodiments, the disclosed subject matter described herein relates to a process, further including adding a fluid super saturated with a gas to the treated aqueous media recycled to the inlet of the vessel.

In some embodiments, the disclosed subject matter described herein relates to a process, further including adding a fluid super saturated with gas to the aqueous media upstream of the first dynamic zone.

In some embodiments, the disclosed subject matter described herein relates to a process, further including detecting a level of cavitation and adjusting a speed of a first rotor and/or a second rotor in response to a detected level of cavitation in the aqueous media.

In some embodiments, the disclosed subject matter described herein relates to a process, further including comparing the detected level of cavitation against a set point and adjusting the speed based on the comparison.

In some embodiments, the disclosed subject matter described herein relates to an apparatus for treating an aqueous media including organic constituents and microorganisms by causing cavitation in the aqueous media including: a vessel including an inlet and an outlet, a first rotor and a second rotor, the second rotor spaced from the first rotor to define a static zone between the first rotor and the second rotor; and a volume displaced by the second rotor in one revolution is greater than the volume displaced by the first rotor in one revolution.

In some embodiments, the disclosed subject matter described herein relates to an apparatus, wherein volume of the vessel between the first rotor and the second rotor includes at least three times the volume displaced by the first rotor in one revolution.

In some embodiments, the disclosed subject matter described herein relates to an apparatus, wherein the first rotor is preceded by a plurality of rotors together including a first rotor assembly.

In some embodiments, the disclosed subject matter described herein relates to an apparatus, wherein the second rotor is succeeded by a plurality of rotors together including a second rotor assembly.

In some embodiments, the disclosed subject matter described herein relates to an apparatus, wherein the static zone is defined by a wall of non-metallic material.

In some embodiments, the disclosed subject matter described herein relates to an apparatus, wherein one of the first rotor or the second rotor includes an impeller.

In some embodiments, the disclosed subject matter described herein relates to an apparatus, wherein the first rotor and/or the second rotor includes a turbine.

In some embodiments, the disclosed subject matter described herein relates to an apparatus, further including a sensor to detect a level of cavitation in the aqueous media and adjust a speed of the first rotor and/or the second rotor to a level of detection of cavitation in the aqueous media.

In some embodiments, the disclosed subject matter described herein relates to an apparatus, further including comparing the detected level of cavitation against a set point and adjusting the speed based on the comparison.

In some embodiments, the disclosed subject matter described herein relates to an apparatus, further including comparing the detected level of cavitation against a set point and adjusting the speed based on the comparison.

In some embodiments, the disclosed subject matter described herein relates to a process for treating an aqueous media including organic constituents and microorganisms by causing cavitation in the aqueous media including: increasing a first velocity of the aqueous media in a first dynamic zone; decreasing a second velocity of the aqueous media in a static zone; and increasing a third velocity of the aqueous media in a second dynamic zone.

In some embodiments, the disclosed subject matter described herein relates to a process wherein a first potential volume displaced by the second dynamic zone is greater than the second potential volume displaced by the first dynamic zone.

In some embodiments, the disclosed subject matter described herein relates to a process, wherein an increase in the first velocity results in an increase in angular momentum of components in the aqueous media.

In some embodiments, the disclosed subject matter described herein relates to a process, wherein the second dynamic zone is downstream of the first dynamic zone.

In some embodiments, the disclosed subject matter described herein relates to a process, wherein the static zone is downstream of the first dynamic zone.

In some embodiments, the disclosed subject matter described herein relates to a process, further including increasing non-linear acceleration in the first dynamic zone.

In some embodiments, the disclosed subject matter described herein relates to a process, further including increasing the non-linear acceleration of the aqueous media in the second dynamic zone.

In some embodiments, the disclosed subject matter described herein relates to a process, further including revolving a rotor to impart angular momentum to components in the aqueous media.

In some embodiments, the disclosed subject matter described herein relates to a process, further including decreasing a non-linear acceleration of the aqueous media in the static zone.

In some embodiments, the disclosed subject matter described herein relates to a process, wherein a volumetric flow rate of the aqueous media through the static zone is no more than ⅓ of the volumetric flow rate through the first dynamic zone.

In some embodiments, the disclosed subject matter described herein relates to a process, further including feeding the aqueous media to an inlet to a vessel including the first dynamic zone, the static zone and the second dynamic zone and discharging treated aqueous media from an outlet from the vessel.

In some embodiments, the disclosed subject matter described herein relates to a process, further including recycling a treated aqueous media to the inlet to the vessel.

In some embodiments, the disclosed subject matter described herein relates to a process, further including adding a fluid super saturated with gas to the treated aqueous media recycled to the inlet to the vessel.

In some embodiments, the disclosed subject matter described herein relates to a process, further including adding a fluid super saturated with gas to the aqueous media upstream of the first dynamic zone.

In some embodiments, the disclosed subject matter described herein relates to a process, further including detecting a level of cavitation and adjusting a speed of a first rotor and/or a second rotor in response to the detected level of cavitation in the aqueous media.

In some embodiments, the disclosed subject matter described herein relates to a process, further including comparing the detected level of cavitation against a set point and adjusting the speed based on the comparison.

Other technical features may be readily apparent to one skilled in the art from the following figures, descriptions, and claims.

### BRIEF DESCRIPTION OF THE DRAWINGS

For a more complete understanding of this disclosure, reference is now made to the following description, taken in conjunction with the accompanying drawings, in which:

FIG. 1 is an example schematic illustration of a first embodiment of the apparatus of the present disclosure;

FIG. 2 is an example schematic illustration of a second embodiment of the apparatus of the present disclosure; and

FIG. 3 is an example schematic illustration of a third embodiment of the apparatus of the present disclosure.

FIG. 4 is an isometric view of a rotor in accordance with an embodiment of the of the present disclosure.

FIG. 5 is a side view of a rotor in accordance with an embodiment of the of the present disclosure.

FIG. 6 is a cross-sectional view of a rotor in accordance with an embodiment of the present disclosure.

FIG. 7 is an isometric view of a rotor in accordance with an embodiment of the of the present disclosure.

FIG. 8 is a back view of a rotor in accordance with an embodiment of the of the present disclosure.

### DETAILED DESCRIPTION

The figures, discussed below, and the various embodiments used to describe the principles of the present invention in this patent document are by way of illustration only and should not be construed in any way to limit the scope of the invention. Those skilled in the art will understand that the principles of the invention may be implemented in any type of suitably arranged device or system.

An apparatus and process are disclosed for treating an aqueous medium having one or more targeted constituents such as, organics, organically complexed inorganics, organometallics, persistent organic molecules, biologics, microorganisms, and microorganisms associated with biomasses. The apparatus and process conditions an incoming aqueous media from a non-compressible Newtonian fluid, to a multiphase, compressible, complex solution, with an elevated tendency to exhibit fluid fracture under less rigorous shear and hydrodynamic forces, including effects due to micro-particulates (especially those with irregular structure); undissolved gases adhering to solid particles, vapor filled cavities formed in crevices of system structure and solids; stable microbubbles; and, salt crystal formation occurrence within the aqueous media. The process creating the conditions for nucleation sites and seeding events, which are highly advantageous to cavitation propagation at lower energies. Common cavitation nucleation sites include micro-particulates (especially with irregular structure), undissolved gases adhering to solid particles, vapor filled cavities in crevices of system structure and solids, microbubbles, and salt crystal formation occurrence within the aqueous media.

In one aspect, the apparatus and process described herein provide an efficient, non-chemical, low energy, and cost-effective new method to treat aqueous media to substantially reduce or eliminate disposal requirements for aqueous media containing organics, microorganisms, and other biologic constituents associated with biomasses. A further unique aspect of this apparatus is a reduction of the need to dispose of the waste byproducts of the organic and inorganic constituents associated with the treatment of organic sludges, waste activated sludges, and microbial biomasses. The aqueous media is treated such that it is acceptable as a raw material source and an environmentally advantageous waste to product process, including but not limited to; bioreactor nutrients; a dewatered carbon source for energy recovery and for Class A biosolids rendered for fertilizers; carbon Greenhouse Gas CO2e credits; reduced manpower and equipment costs; and small installation footprints.

An immediate economic result comes from providing a lower cost of operation as a result of lowered transport and disposal costs, lowered treatment plant operation energy costs, elimination of or reduction in chemical costs, and other costs. Including, valorizing the treated aqueous media as a raw material source for agricultural fertilizers, an energy source for thermal and power processes, a nutrient source for industrial and certain municipal activated sludge industrial wastewater treatment processes, a significant source of Greenhouse Gas CO2e credits, and potential ESG credits. The apparatus with engineered components, its small installation footprint, and process of the disclosure described herein is relatively simple in construction and operates on lower levels of energy than conventional treatment processes capable of meeting these treatment objectives. This adds to the cost-efficiency, and adoption viability of the overall apparatus and integrated process.

The apparatus exposes the conditioned aqueous media to a first one or more actuator driven rotors, and a second one or more actuator driven rotors, the second one or more rotors spaced from the first one or more rotors to define a static zone. The one or more first rotors, the static zone and the second one or more rotors may be enclosed within the same treatment vessel and may be operated by an actuator capable of variable rotational velocities. The rotors create non-Newtonian flow characteristics within the aqueous media, by exposing the aqueous media to nonlinear and non-uniform acceleration primarily composed of rotational vectors with a significant centripetal force component that causes de-fluidized components of the aqueous media to be imparted with an increase in angular momentum above that of the aqueous media fluid component; imbued with a significant differential in velocity between that of the fluid component and the de-fluidized components to create both rapid (near explosive) decompression of the aqueous media by a near-instantaneous transition from high dynamic flow conditions to more stationary flow conditions, and both a greater number of symmetric cavitation events, energies and their effects and asymmetric cavitation events, energies, and their effects caused by transference of angular momentum from the de-fluidized components, to incept an increase in asymmetric cavitation events within aqueous media, above that normally anticipated within a fluid; as the aqueous media enters transitions through the static zone thereby resulting in physical, oxidative, free-radical oxidative, and other cavitational energies, and their effects, to destruct aqueous media contaminants, above that achievable from conventional low energy hydrodynamic, and hydropneumatic system technology, at greatly reduced energy and equipment costs.

Regardless of how changes in hydrodynamic conditions are caused, the presence of nucleation sites, or seeding events, are highly advantageous to cavitation propagation at lower energies. Common cavitation nucleation sites include micro-particulates (especially with irregular structure), undissolved gasses adhering to solid particles, vapor filled cavities in crevices of system structure or solids, microbubbles, or salt crystal formation occurrence within the aqueous media.

The terms “treating”, “treatment” or “treated” is meant to include oxidation and advanced oxidative destruction, mechanical and hydrodynamic shear, dispersion and lysis, and physical destruction through cavitation events, energies, and their effects. It also includes destruction of persistent organic compounds and biologics through higher energy asymmetric cavitation events, energies, and their effects. The terms “treating”, “treatment”, or “treated” is also meant to include destruction using a high incidence of contact of the constituents in the aqueous media to higher energy cavitation and other energetic destruction mechanisms, augmented through an induced increase in angular momentum resultant from nonlinear acceleration developed on aqueous media constituents isolated from the main fluid body, by process developed non-Newtonian flow.

The term “aqueous media” is meant to include aqueous solutions or suspensions, any or all of any class of organic, organometallic, haloorganic, organically complexed inorganic, oxidizable inorganic, biological constituents such as microorganisms, and microorganisms associated with biomasses, oxidized, destructed and lysed organic constituents, and byproducts of microorganism biomass dispersion, destruction, and lysing, including cellular wall components, microorganism cytoplasm and other microorganism cellular contents. Aqueous media may also include and contain unlysed and or incompletely lysed microorganisms, and encysted microorganisms, and microorganisms remaining in coherent colonies, and low viability microorganisms as may be present in municipal, agricultural, maricultural, industrial, pharmaceutical, chemical processing, abattoir, food processing, water treatment, desalination process, feedwater, intermediate process water, wastewater, waste sludges, leachates, stormwater runoff from agricultural, suburban, urban development, and other similar applications.

The term “recycled” is meant to include the activities by which the treated aqueous media is collected and further treated, retreated, or used as a raw material, nutrient, or other beneficial use. Non-limiting examples may include components for agricultural fertilizer, fuel sources for thermal or energy recovery, or nutrient feeds for aqueous biological processes.

The term “nutrient” as used herein refers to any substance that can be used by cells, microbes, or microorganisms in order to multiply or grow. It can be minerals such as calcium, potassium, and molecules such as amino-acids, peptides, proteins, saccharides, polysaccharides, or the like that can be used, as well as cell wall material.

In a first preferred embodiment of the present disclosure, the aqueous media containing organic constituents is exposed to physical forces including centripetal forces, high velocity shear forces, high energy oxidation events, energies and extreme localized thermic energies resulting from the method of the novel cavitation inducing apparatus. The apparatus may comprise a first multi-rotor assembly comprising at least a first rotor, a substantially static and non-rotating zone adjacent the first rotor, and a second rotor spaced apart from the first rotor by the static zone. The first rotor and the second rotor and the static zone may be contained within a treatment vessel or cylindrical body. The apparatus may further comprise at least a second multi-rotor assembly, comprising at least a third rotor, a substantially static and non-rotating zone adjacent the third rotor, and a fourth rotor spaced away from the third rotor by the static zone and a substantially static and non-rotating zone adjacent the first multi-rotor assembly. The first and the second multi-rotor assemblies and non-rotating static zones may be contained within a treatment vessel or a cylindrical body. The aqueous media containing the organic constituents is introduced on a first end of the treatment vessel and flows to the first rotor wherein the aqueous media is subsequently transferred to the static zone and then to the second rotor, to the third rotor of the second multi-rotor assembly and its non-rotating static zone and to the fourth rotor to be discharged from the vessel from an outlet port. The aqueous media circulated in the vessel is repeatedly exposed to cavitation forces within the vessel that cause oxidation, dispersion, destruction and lysing of the organic contaminates contained in the aqueous media until expelled for further treatment or for final use through the outlet port.

In a second embodiment of the present disclosure, gas-supersaturated fluid is introduced to the aqueous media at the inlet port to the treatment vessel directly or by introduction into the treatment vessel inlet recycle source, the gas-supersaturated fluid having a higher partial pressure of gases than the total fluid pressure of the aqueous media being input to the treatment vessel. The gas-supersaturated fluid thereby created, containing high levels of stable microbubbles, by having maintained these high-pressure gas supersaturated conditions, under low hydraulic shear, conditions for a sufficient period of time determined by the fluid supersaturation pressure, to further act as seeding components to more easily incept cavitation within the treatment vessel.

In a third embodiment of the present disclosure, aqueous media enters through an inlet port into a saturation vessel, in which the entirety of the flow is exposed to gas-supersaturation at high pressures, above at least four atmospheres, and for a sufficient time such that stable microbubbles are formed under gas-supersaturated conditions, and such that the aqueous media becomes a multiphase solution by means of gas-supersaturation above solubility limits of the solution. The gas-supersaturated aqueous media is created to contain high levels of microbubbles. The microbubbles are created by maintaining the high pressure gas supersaturated conditions, under low hydraulic shear conditions, for a sufficient period of time as determined by the fluid supersaturation pressure and discharged to the treatment vessel. The multiphase aqueous media solution now presents as a compressible, complex fluid, containing stable microbubbles to act as seeding components to incept cavitation more easily. The multiphase aqueous media may be charged to the treatment vessel through an inlet port to be subjected to additional energies and forces.

In a fourth embodiment of the present disclosure, all or a portion of the aqueous media exiting the treatment vessel outlet port, is recycled to enter into a saturation vessel through an inlet port. The entirety of this recycled flow is then exposed to gas-supersaturation at high pressures, above at least four atmospheres, and for a sufficient time such that stable microbubbles are formed under supersaturated conditions, and such that the aqueous media becomes a multiphase solution by means of gas-supersaturation above solubility limits of the solution. The gas-supersaturated fluid is created so as to contain high levels of microbubbles, by having maintained these high-pressure gas supersaturated conditions, under low hydraulic shear, conditions for a sufficient period of time determined by the fluid supersaturation pressure, when charged to the treatment vessel. The multiphase aqueous media solution now presents as a compressible, complex fluid, containing stable microbubbles to act as seeding components to incept cavitation more easily. The multiphase aqueous media solution may be charged to the treatment vessel through an inlet port to be subjected to additional energies and forces.

The present invention will now be described in detail for specific preferred embodiments of the invention, it being understood that these embodiments are intended only as illustrative examples, and the invention is not to be limited thereto.

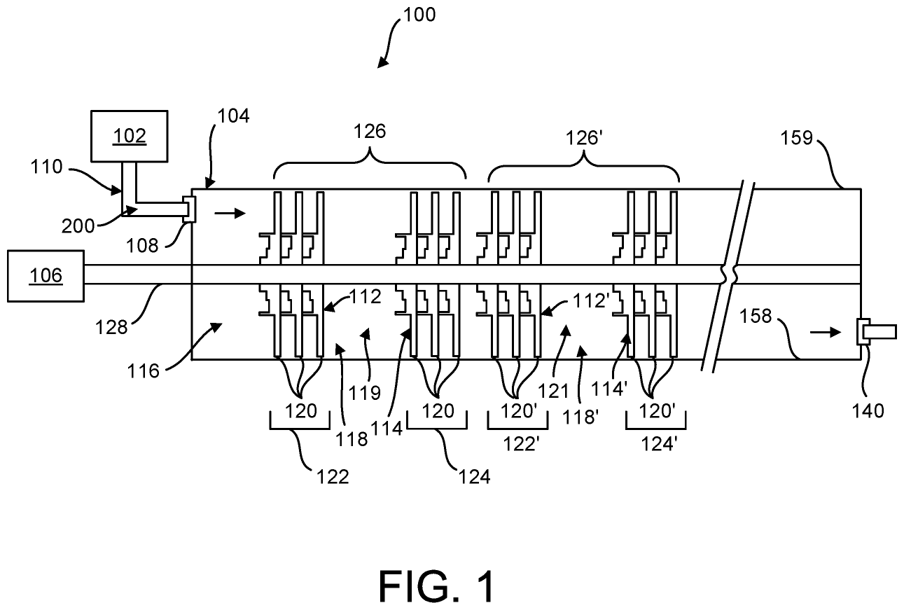

FIGS. 1-3 schematically illustrate specific preferred embodiments of the present disclosure providing an apparatus 100 for the treatment of aqueous media that includes a delivery component such as a fluid pump, or pressurized source 102 of aqueous media, a treatment vessel 104, and an actuator 106. The fluid pump or pressurized source 102 is adapted to introduce a fluid containing the aqueous media to the treatment vessel 104 to an inlet port 108 via a pipeline 110. The treatment vessel 104 is preferably tubular in shape that includes a first rotor 112 and a second rotor 114 housed within an interior 116 of the treatment vessel 104. The first rotor 112 and the second rotor 114 may be spaced apart from each other to define a static zone 118.

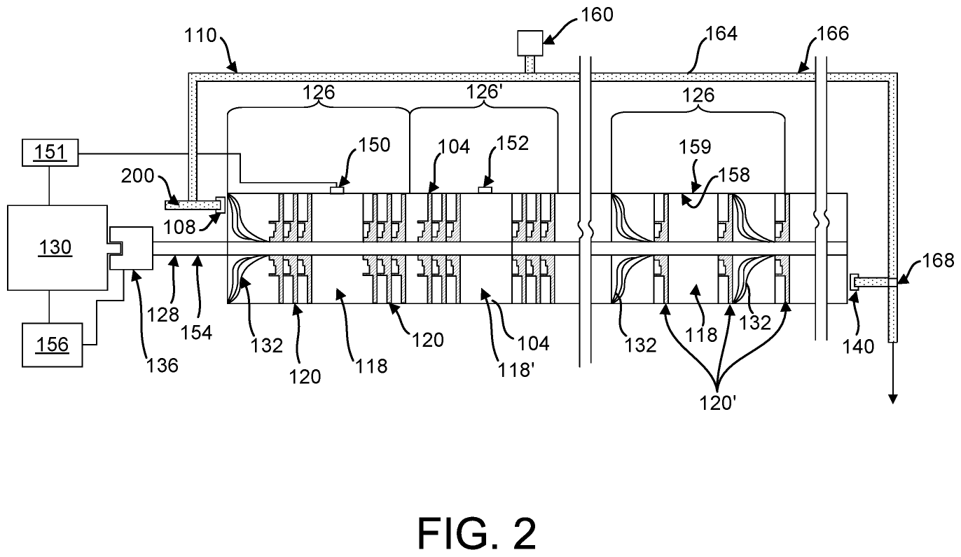

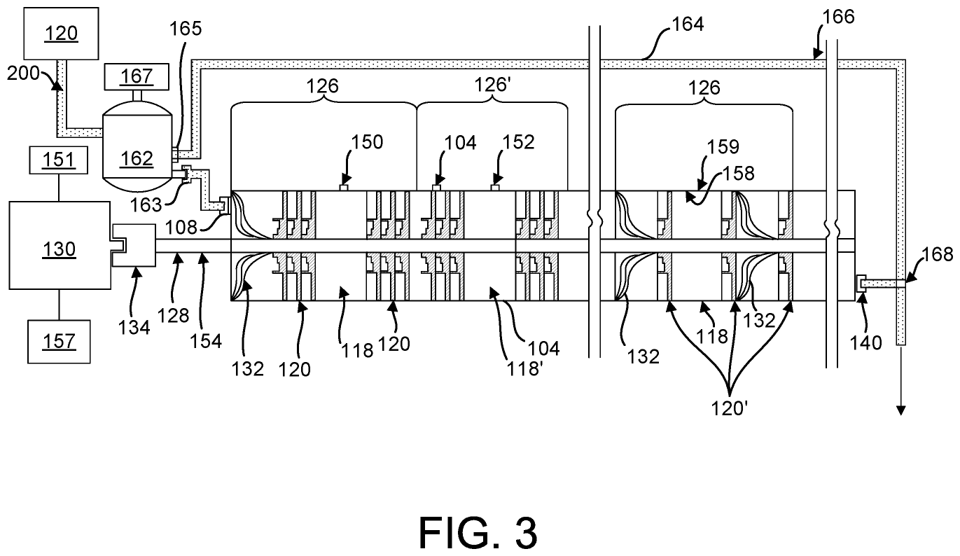

In an embodiment, the first rotor 112 may be the last of three rotors 120 that comprise a first rotor assembly 122. Moreover, the second rotor 114 may be the first of three rotors 120 that comprise a second rotor assembly 124 that effect cavitation as aqueous media flows through each multi-rotor assembly 126, 126′. A drive shaft 128 mechanically connects each rotor 120 to the actuator 106 within the interior 116 of the treatment vessel 104. Each multi-rotor assembly 126, 126′ may affect cavitation in more than one stage as aqueous media flows through each multi-rotor assembly 126, 126′. The drive shaft 128 mechanically connects each multi-rotor assembly 126, 126′ to the actuator 106. As seen in FIGS. 2-3, the actuator 106, that may comprise an electrically driven, hydraulically driven, or other externally powered motor 130, a drive component 134, or a mechanical variable speed drive 136. The drive component 134, or mechanical variable speed drive 136 is arranged to impart controllable longitudinal rotational motion about a central axis of the drive shaft 128 associated with each multi-rotor assembly 126, 126′ and to impart rotational motion to each multi-rotor assembly 126, 126′.

A stream of aqueous media is introduced, by the fluid pump or pressurized source 120, through the inlet port 108 into the interior of the treatment vessel 10, where the fluid undergoes cavitation multiple times resulting from the forces, energies and actions presented by each multi-rotor assembly 126, 126′ and is discharged from the treatment vessel 104 at an outlet port 140 thereof. Preferably, the treatment vessel 104 employed in the present embodiment operates in various treatment applications within a pressure ranging from between about 4 bar (g) (60 psig) and about 40 bar (g) (600 psig). The pressures applicable to the representative treatment applications being employed as defined above.

The actuator 30 facilitates fluid flow through the treatment vessel 104 and to each multi-rotor assembly 126, 126′ by rotation of the drive shaft 128 between about 1,000 RPM to about 6,000 RPM. The selection of rotational speed of the drive shaft 128 is dependent on the aqueous media undergoing treatment. The actuator 106 and its included motor 130 and drive component 134 and/or mechanical variable speed drive 136 may be located on the exterior of the treatment vessel 104 and connected the drive shaft 128 with only the drive shaft 128 penetrating an exterior wall 159 of the treatment vessel 104 into the interior 116. Alternatively, the actuator 106 and drive shaft 128 may be fluid submersible and contained in the interior 116 of the treatment vessel 104.

As shown in FIG. 2, one or more sensors, such as for example, a low light optical sensor (not shown), a photon counter 150, an audio analyzer (not shown), or an audio spectrum analyzer 152, or a vibration sensor (not shown), or motor shaft vibration sensor 154, or other sensor, may be used to detect and convey signals or useable information to a variable speed motor controller 156, or other similar component suitable to receive and interpret the signals and information from the sensors, and provide an appropriate output from the variable speed motor controller 156, to the motor 130 and the mechanical variable speed drive 136 so that the multi-rotor assembly 126 is driven at the appropriate rotational velocity determined as rotations per minute, rotations per second, and other such determined set points. In an embodiment a motor frequency control drive 157 is configured to control the motor 130. Specifically, the sensors may detect the intensity of cavitation events at a strategic location(s) in the treatment vessel 104 and signals the detected intensity to the variable speed motor controller 156. A cavitation analyzer 151 may be connected between the photon counter 150 and the motor 130. The cavitation analyzer 151 may be configured to determine and/or predict a preferred speed of the variable speed motor controller 156 based on a specific set of conditions. The variable speed motor controller 156 may be configured to compare the intensity level of cavitation events to a set point programmed into the variable speed motor controller 156. If a cavitation intensity level is above or below a control set point, the variable speed motor controller 156 may signal the motor 130 to increase or decrease rotational velocity, as appropriate, of the motor 130 and thus the speed of the multi-rotor assemblies 126, 126′. Analog signals and predictive algorithms may also be used such that changes in the rotational velocity of the motor 130 may be made prior to a specific set point being reached or exceeded.

As illustrated in FIG. 1, multi-rotor assembly 126, is comprised of a first rotor 112 and one or more rotors 120 arranged upstream of the first rotor 112, and a second rotor 114 spaced from the first rotor 112 to define a first static zone 119 between the first rotor 112 and the second rotor 114. One or more rotors 120 may be arranged downstream of the first rotor 112 defining a first rotor assembly 122. One or more rotors 120 may be arranged downstream of the second rotor 114 defining a second rotor assembly 124. A first multi-rotor assembly 126 may comprise the first rotor assembly 122 and the second rotor assembly 124. The first rotor assembly 122 and the second rotor assembly 124 may each comprise an arrangement of three rotors closely positioned to each other. A second multi-rotor assembly 126′ may include a third rotor 112′ and one or more rotors 120′ arranged upstream of the third rotor 112′, placed in series following the second rotor assembly 124, and a fourth rotor 114′, spaced from the third rotor 112′ to define a second static zone 121 between the third rotor 112′ and the fourth rotor 114′. A third motor assembly 122′ may comprise the third rotor 112′ and one or more rotors 120′. One or more rotors 120′ may be arranged downstream of the fourth rotor 114′. The fourth rotor 114′ and the one or more rotors 120′ may comprise the fourth rotor assembly 124′.

Preferably the third motor assembly 122′ and the fourth rotor assembly 124′ may each comprise an arrangement of at least three rotors. The static zones 118, 118′, 119 and 121 may be defined by either a wall of metallic material, or a wall of non-metallic material in order facilitate incorporation of apparatus and process methods, to introduce electric, magnetic, and other electroweak forces to generate further cavitation events, especially asymmetric cavitation events, energies, and effects.

More than the two multi-rotor assemblies 126, 126′ shown in FIG. 1 may be installed within the treatment vessel 104 to effect treatment of the aqueous media and the two multi-rotor assemblies 126, 126′ shown in FIG. 1 are used for the case of explanation for the embodiment of the disclosure. Upon entry of the aqueous media into a first static zone 119, located downstream from the first rotor 112 or the second static zone 121 downstream from the third rotor 112′ the velocity and pressure of the compressible, complex aqueous media and aqueous media component, containing stable microbubbles is decreased to a second velocity and pressure. The velocity and pressure of the aqueous media is again increased to a third velocity and pressure by the second rotor 114 or fourth rotor 114′, located downstream from the first static zone 118 and the second static zone 121, respectively.

Each static zone 118, 118′ defines a volume between the first rotor and the second rotor that may contain an open volume that may contain fluid during operation that is any one of, not less than three times greater than the volume of fluid displaced by one rotation of the first rotor 112 of the first rotor assembly 122. The volume of the static zone 118 is sized to effect a 90% decrease of the fluid velocity initially exiting the first rotor 112 of the first rotor assembly 122, prior to entering the second rotor 114 which is the first rotor of the second rotor assembly 124, or a volume higher, or between, these values determined to be most appropriate to the aqueous media to be treated. The first rotor 112 is the last rotor in the first rotor assembly 122 and the second rotor 114 is the first rotor in the second rotor assembly 124. No mechanical equipment is rotating in the first static zone 119.

In a further embodiment, the volume displaced by the second rotor 114 in one revolution about its axis is greater than the volume displaced by the first rotor 112 in one revolution about its axis. The greater volumetric flow rate downstream of the first static zone 119 than upstream of the first static zone 119 stresses the fluid body through rapid pulsed decompressions and recompressions, causing non-uniform deformation of the fluid body and nonuniform changes in localized densities and velocities (shear stresses) of the gas supersaturated multiphase solution, so to approach and exceed fluid fracture conditions. Cavitation nucleation sites, including microbubbles and fine particulates under heterogenous nucleation conditions, result in greater cavitation inception frequency and an increase in cavitation events, and an increase in asymmetric cavitation events, energies and effects.

The inclusion of the second multi-rotor assembly 126′, in series, following the first multi-rotor assembly 126 and within the treatment vessel 104, will provide additional treatment effects to the aqueous media in the treatment vessel.

While not being bound by theory, each individual rotor in the multi-rotor assembly, acts as a dynamic zone designed to increase the rotational velocity of each rotor containing the compressible, complex aqueous media, containing stable microbubbles within each rotor, by the action of the actuator 106 attached to the drive shaft 128. The rotors 120, 120′ of each of the multi-rotor assemblies 126, 126′ are comprised of an impeller or turbine of a type used in single-stage and multi-stage pumps, or modified versions thereof. In other aspects of the present arrangements, the rotors 120, 120′ may feature turbine rotors 132 of a type used in single-stage and multi-stage fluid pumps, or modified versions thereof and used to achieve a specific treatment objective for a specific aqueous media. Each impeller and turbine rotor is mechanically connected to the drive shaft 128 and turned at the rotational speed provided by the actuator 106. Each of the rotors 120, 120′ of each multi-rotor assembly 126, 126′ when fixedly mounted on the drive shaft 128 has a diameter providing a close clearance to the interior wall 158 of the treatment vessel 104.

The rotational velocity imparted by each of the rotor(s) of the multi-rotor assemblies 126, 126′ causing the multiphase, compressible, complex aqueous media, containing stable microbubbles to increase from near-zero rotations per minute (RPM) at the inlet to each rotor, to the higher rotational velocity at the selected operating rotations per minute (RPM) at the outlet port of each rotor. The centrifugal motion, of the aqueous media following a non-uniform curved path within each rotor blade or vane of each rotor, causing increasing nonlinear and non-uniform acceleration forces primarily composed by rotational and non-uniform force vectors with a significant centripetal force vector component as the aqueous media progresses from each rotor blade or vane entry section, to each rotor blade or vane outlet section. Higher rotational and centripetal forces occur along the trailing face of the curved rotor blade or vane, than at the leading face, so as to cause a differential in rotational acceleration and centripetal forces, to further cause separation of the higher mass and components carried within the aqueous media to present non-Newtonian flow characteristics, that cause an accumulation of these separated components nearer to the trailing face of each rotor vane, of each rotor, thereby exposing these separated components to significantly greater nonlinear acceleration and rotational forces, so as to cause an increase in the angular momentum of these separated aqueous media components to above that of the angular momentum of the aqueous media fluid component.

Further, the increasing volume of each rotor vane of each individual rotor of each of the multi-rotor assemblies results in a net linear velocity decrease of said aqueous media fluid component so as to cause a net increase in the pressure of the aqueous media component as a whole. This net pressure increase causes compression of the compressible, complex aqueous media component, containing stable microbubbles thereby increasing the potential energy release and de-solubilization energy release from said aqueous media upon entry into a static zone 118, 118′.

Successive passes through the rotors 120, 120′ results in increasing pressure, increasing potential energy and increasing non-Newtonian flow characteristics of the compressible, complex aqueous media and aqueous media component, containing stable microbubbles, until the aqueous media is released into a static zone 118, 118′. The successive passes though the rotors of the multi-rotor assemblies 126, 126′ repeatedly exposes the aqueous media to cavitation forces within the vessel that cause oxidation, dispersion, destruction and lysing of the organic contaminates contained in the aqueous media until the treated aqueous media is expelled through an outlet port 140 from the treatment vessel 104 for further treatment or for final use.

With reference to FIG. 2, a second embodiment of the present disclosure is illustrated. In this second embodiment a gas-supersaturated fluid is introduced to the aqueous media 200 at the inlet port 108 to the treatment vessel 104 from a source of gas saturated fluid 160 via a pipeline 110. The gas-supersaturated fluid having a higher partial pressure of gases than the total fluid pressure of the aqueous media being input to the treatment vessel 104. The gas-supersaturated fluid thereby created, containing high levels of stable microbubbles to further act as seeding components to more easily incept cavitation within the treatment vessel 104.

With reference to FIG. 3 and a third embodiment of the present disclosure, aqueous media 200 enters through an inlet port 108 into a saturation vessel 162, in which the entirety of the flow is exposed to gas-supersaturation at high pressures, above at least 4 atmospheres, and for a sufficient time such that stable microbubbles are formed under supersaturated conditions, and such that the aqueous media 200 becomes a multiphase solution by means of gas-supersaturation above gas solubility limits of the solution. The gas-supersaturated aqueous media is created so as to contain high levels of microbubbles when discharged to the treatment vessel 104. The saturation vessel 162 may comprise a pressurized gas source 167 configured to pressurize the saturation vessel 162. The saturation vessel 162 may comprise a pressure controller 163 to control the outlet pressure of the saturation vessel 162. The multiphase aqueous media solution now presents as a compressible, complex fluid, containing stable microbubbles to act as seeding components to more easily incept cavitation, and is then discharged to the treatment vessel 104 and input to inlet port 108 to be subjected to additional energies and forces.

In a fourth embodiment of the present disclosure all or a portion of the aqueous media exiting the treatment vessel 104 outlet port 140, may be recycled via recycle line 164 to enter into a saturation vessel 162 through an recycle inlet port 165. The amount of treated aqueous media recycle 166 recycled to the saturation vessel 162 may be controlled by means of a ratio controller 168 connected to the outlet port 140. The entirety of the treated aqueous media recycle 166 may then be exposed to gas-supersaturation at high pressures, above at least 4 atmospheres, and for a sufficient time such that stable microbubbles are formed under supersaturated conditions, and such that the aqueous media becomes a multiphase solution by means of gas-supersaturation above solubility limits of the solution. The gas-supersaturated fluid is created so as to contain high levels of microbubbles when discharged to the treatment vessel 104. The multiphase aqueous media solution now presents as a compressible, complex fluid, containing stable microbubbles to act as seeding components to more easily incept cavitation, and is then discharged to the treatment vessel 104 and input to the inlet port 108 to be subjected to additional energies and forces.

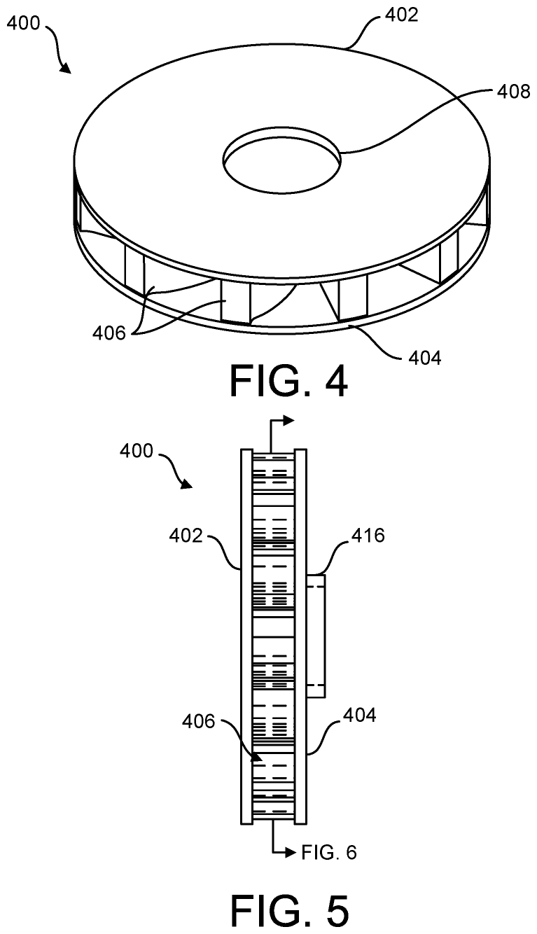

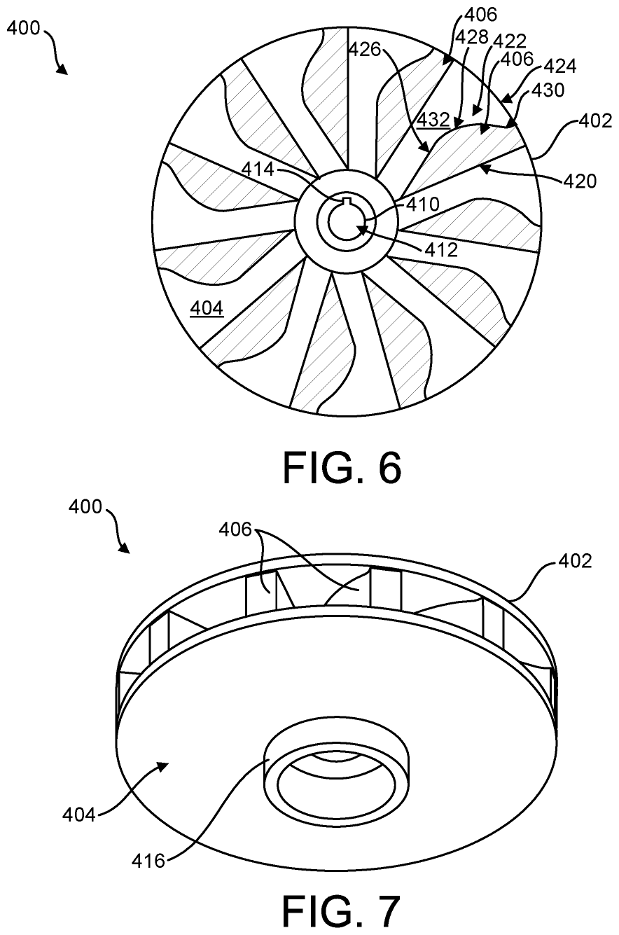

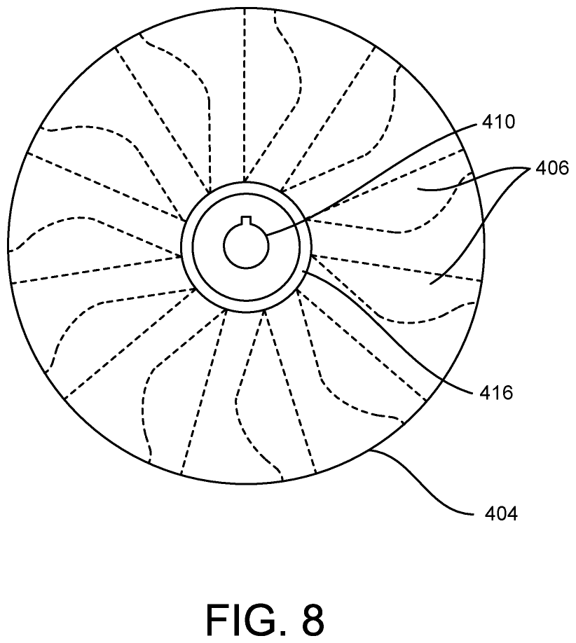

Referring to FIGS. 4-8, the rotors 120, 120′ may comprise a closed impeller rotor 400 comprising a front plate 402, a back plate 404 generally parallel to the front plate 402, and a plurality of vanes 406 connected between the front plate 402 and the back plate 404. In an embodiment, the front plate 402 and the back plate 404 are separated by a first distance of between about 0.25 inches and about 4 inches. In an embodiment, the front plate 402 and the back plate 404 may have a first diameter between about 2 inches and about 18 inches. In another embodiment, the first diameter is about 6 inches. The front plate 402 may comprise an inlet 408 being concentric with the center of the front plate 402, wherein the inlet 408 is configured to allow for the inflow of aqueous media between the front plate 402 and the back plate 404. In an embodiment the inlet 408 may have a second diameter of between about 0.25 inches and 4 inches. In another embodiment, the second diameter may be about 1.8 inches.

In an embodiment, the back plate 404 may comprise keyway 410 configured to receive the drive shaft 128. The keyway 410 may comprise a bore 412 configured to abut the drive shaft 128; and a slot 414 configured to rotationally engage the drive shaft 128.

In an embodiment, the back plate 404 may comprise a rear hub 416 extending outwardly and away from the back plate 404; where in the rear hub 416 is centrally disposed upon the back plate 404. The rear hub 416 may comprise a cylindrical shape in which the drive shaft 128 extends through the center of the rear hub 416.

In an embodiment, each vane of the plurality of vanes 406 comprises a leading face 420 and a dynamic face 422. The leading face 420 may extend from a peripheral edge 424 of the back plate 404 towards the inlet 408; wherein the leading face 420 is bounded between the front plate 402 and the back plate 404. The leading face 420 and dynamic face 422 may be generally perpendicular to the front plate 402 and the back plate 404. The dynamic face 422 may comprise a straight face 426 extending from the leading face 420 proximate the inlet 408. In an embodiment, the straight face 426 is generally perpendicular to the leading face 420 of an adjacent vane. The dynamic face 422 may further comprise a parabolic face 428 extending outwardly from the leading face 420 and towards the leading face 420. The dynamic face 422 may further comprise a hyperbolic face 430 extending outwardly towards the peripheral edge 424.

In an embodiment the plurality of vanes 406 may comprise eleven vanes equally spaced around the peripheral edge 424.

The straight face 426 of the plurality of vanes 406 is integral in preparing the incoming fluid for separation of the gaseous and fluid components from the non-fluid targeted contaminants. The straight face 426 forms a channel 432 with the leading face 420 and the straight face 426 and is parallel to the same. Centripetal forces act as a centrifuge, forcing the gaseous and fluid components nearer the leading face 420, and the non-fluid target contaminants nearer the straight face 426.

A further function of straight face 426 is to create inertia of the gaseous and fluid components separated from the non-fluid target contaminants by centripetal and other forces so that these continue in a straight path to jet into the static zone 118, 118′ significantly prior to the de-fluidized target components such that cavitation inception and fully developed cavitation occurs prior to subsequent entry of the target contaminants.

The parabolic face 428 of the dynamic face 422 further separates the gaseous and fluid components from the non-fluid targeted contaminants. The parabolic face 428 provides high levels of non-linear acceleration vectors creating non-Newtonian flow to further separate gaseous and fluid components from the targeted non-fluid contaminants and induced increases in angular momentum of these.

The distance, the non-fluid components must travel as compares to the gaseous and fluid components, together with the opening angle increase in distance from the leading face 420, further cause a delay of entry of the non-fluid target contaminants into the subsequent static zone 118, 118′.

Increasing non-linear force vectors act on the substantively de-fluidized target components to increase their angular momentum prior to their delayed release into the static zone 118, 118′ which is undergoing incipient and fully developed cavitation events. The angular momentum component of the target contaminants will create a preferred increase in the ratio of advantageous asymmetric cavitation events, energies and their effects to symmetric cavitation events.

The hyperbolic face 430 of the dynamic face 422 presents a final advantageous increase of angular momentum to the maximally de-watered target contaminants and adjusts the entry angle of these target contaminants to an advantageous angle prior to entry into the incipient and fully developed cavitation occurring in the static zone 118, 118′, caused by the gaseous and fluid components previously jetted into the static zone 118, 118′ at the leading face 420 further separates the gaseous and fluid components from the non-fluid targeted contaminants. The parabolic face 428 provides high levels of non-linear acceleration vectors creating non-Newtonian flow to further separate gaseous and fluid components from the targeted non-fluid contaminants and induced increases in angular momentum of these.

Prior art cell lysis technology required at least 40 times the energy input of the claimed process and apparatus to achieve equivalent cell lysis efficacy.

In an embodiment, a process for treating an aqueous media, may comprise organic constituents and microorganisms by causing cavitation in the aqueous media, comprises the steps of increasing a first velocity of the aqueous media in a first dynamic zone, decreasing a second velocity of the aqueous media in a static zone, and increasing a third velocity of the aqueous media in a second dynamic zone. The second dynamic zone and the static zone may be located downstream of the first dynamic zone. The first velocity may comprise non-linear acceleration. Moreover, the increase in the first velocity, in tandem with further forces, may result in an increase in angular momentum of components in the aqueous media. The process may further comprise increasing non-linear acceleration in the first dynamic zone and increasing the non-linear acceleration of the aqueous media in the second dynamic zone. The process may also comprise, causing non-uniform decreases in both velocity and momentum of the fluid component and de-fluidized components of the aqueous media in the static zone.

In an embodiment, a process for treating an aqueous media comprising organic constituents and microorganisms by causing cavitation in the aqueous media comprising: increasing a first velocity of the aqueous media in a first dynamic zone; decreasing a second velocity of the aqueous media in a static zone; and increasing a third velocity of the aqueous media in a second dynamic zone. In an embodiment, an increase in the first velocity results in an increase in angular momentum of components in the aqueous media.

In an embodiment, the second dynamic zone is downstream of the first dynamic zone and/or the static zone is downstream of the first dynamic zone.

In an embodiment, the process may comprise increasing non-linear acceleration in the first dynamic zone.

In an embodiment, the process may comprise increasing the non-linear acceleration of the aqueous media in the second dynamic zone.

In an embodiment, the process may comprise revolving a rotor to impart angular momentum to components in the aqueous media.

In an embodiment, the process may comprise decreasing a non-linear acceleration of the aqueous media in the static zone.

In an embodiment, the process may comprise a volumetric flow rate of the aqueous media through the static zone is no more than ⅓ of the volumetric flow rate through the first dynamic zone.

In an embodiment, the process may comprise feeding the aqueous media to an inlet to a vessel comprising the first dynamic zone, the static zone and the second dynamic zone and discharging treated aqueous media from an outlet from the vessel.

In an embodiment, the process further comprising recycling treated aqueous media to the inlet of the vessel.

In an embodiment, the process may comprise adding a fluid super saturated with a gas to the treated aqueous media recycled to the inlet of the vessel.

In an embodiment, the process may comprise adding a fluid super saturated with gas to the aqueous media upstream of the first dynamic zone.

In an embodiment, the process may comprise detecting a level of cavitation and adjusting a speed of a first rotor and/or a second rotor in response to a detected level of cavitation in the aqueous media.

In an embodiment, the process may further comprise comparing the detected level of cavitation against a set point and adjusting the speed based on the comparison.

In an embodiment, a process for treating an aqueous media comprising organic constituents and microorganisms by causing cavitation in the aqueous media may comprise: increasing a first velocity of the aqueous media in a first dynamic zone; decreasing a second velocity of the aqueous media in a static zone; and increasing a third velocity of the aqueous media in a second dynamic zone.

In an embodiment, the process may comprise a first potential volume displaced by the second dynamic zone is greater than the second potential volume displaced by the first dynamic zone.

In an embodiment, the process may comprise an increase in the first velocity results in an increase in angular momentum of components in the aqueous media.

In an embodiment, the second dynamic zone of the process is downstream of the first dynamic zone. In a further embodiment, wherein the static zone is downstream of the first dynamic zone.

In an embodiment, the process may comprise increasing non-linear acceleration in the first dynamic zone.

In an embodiment, the process may comprise increasing the non-linear acceleration of the aqueous media in the second dynamic zone.

In an embodiment, the process may comprise revolving a rotor to impart angular momentum to components in the aqueous media.

In an embodiment, the process may comprise decreasing a non-linear acceleration of the aqueous media in the static zone.

In an embodiment, the process may comprise a volumetric flow rate of the aqueous media through the static zone is no more than ⅓ of the volumetric flow rate through the first dynamic zone.

In an embodiment, the process may comprise feeding the aqueous media to an inlet to a vessel comprising the first dynamic zone, the static zone and the second dynamic zone and discharging treated aqueous media from an outlet from the vessel.

In an embodiment, the process may comprise recycling a treated aqueous media to the inlet to the vessel.

In an embodiment, the process may comprise adding a fluid super saturated with gas to the treated aqueous media recycled to the inlet to the vessel.

In an embodiment, the process may comprise adding a fluid super saturated with gas to the aqueous media upstream of the first dynamic zone.

In an embodiment, the process may comprise detecting a level of cavitation and adjusting a speed of a first rotor and/or a second rotor in response to the detected level of cavitation in the aqueous media.

In an embodiment, the process may comprise comparing the detected level of cavitation against a set point and adjusting the speed based on the comparison.

It may be advantageous to set forth definitions of certain words and phrases used throughout this patent document. The term “communicate,” as well as derivatives thereof, encompasses both direct and indirect communication and means that fluid from one component flows to the other component with which it communicates. The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

The description in the present application should not be read as implying that any particular element, step, or function is an essential or critical element that must be included in the claim scope. The scope of patented subject matter is defined only by the allowed claims. Moreover, none of the claims is intended to invoke 35 U.S.C. § 112(f) with respect to any of the appended claims or claim elements unless the exact words “means for” or “step for” are explicitly used in the particular claim, followed by a participle phrase identifying a function. Use of terms such as (but not limited to) “mechanism,” “module,” “device,” “unit,” “component,” “element,” “member,” “apparatus,” “machine,” “system,” or “controller” within a claim is understood and intended to refer to structures known to those skilled in the relevant art, as further modified or enhanced by the features of the claims themselves and is not intended to invoke 35 U.S.C. § 112(f).

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. An apparatus for treating an aqueous media comprising organic constituents and microorganisms by causing cavitation in the aqueous media comprising:
a vessel comprising an inlet and an outlet, a first rotor and a second rotor, the second rotor spaced from the first rotor to define a static zone between the first rotor and the second rotor.

2. The apparatus of claim 1, wherein a first volume of the vessel between the first rotor and the second rotor comprises at least three times a second volume displaced by the first rotor in one revolution.

3. The apparatus of claim 1, wherein a third volume displaced by the second rotor in one revolution is greater than a second volume displaced by the first rotor in one revolution.

4. The apparatus of claim 1, wherein the first rotor is preceded by a plurality of rotors together comprising a first rotor assembly.

5. The apparatus of claim 1, wherein the second rotor is succeeded by a plurality of rotors together comprising a second rotor assembly.

6. The apparatus of claim 1, wherein the static zone is defined by a wall of non-metallic material.

7. The apparatus of claim 1, wherein the first rotor and/or the second rotor comprises an impeller.

8. The apparatus of claim 1, wherein the first rotor and/or the second rotor comprises a turbine.

9. The apparatus of claim 1, further comprising a sensor to detect a level of cavitation in the aqueous media and adjust a speed of the first rotor and/or the second rotor to a level of detection of cavitation in the aqueous media.

10. A process for treating an aqueous media comprising organic constituents and microorganisms by causing cavitation in the aqueous media comprising:
increasing a first velocity of the aqueous media in a first dynamic zone;
decreasing a second velocity of the aqueous media in a static zone; and
increasing a third velocity of the aqueous media in a second dynamic zone.

11. The process of claim 10, wherein an increase in the first velocity results in an increase in angular momentum of components in the aqueous media.

12. The process of claim 10, wherein the second dynamic zone is downstream of the first dynamic zone.

13. The process of claim 10, wherein the static zone is downstream of the first dynamic zone.

14. The process of claim 10, further comprising increasing non-linear acceleration in the first dynamic zone.

15. The process of claim 14, further comprising increasing the non-linear acceleration of the aqueous media in the second dynamic zone.

16. The process of claim 14, further comprising revolving a rotor to impart angular momentum to components in the aqueous media.

17. The process of claim 10, further comprising decreasing a non-linear acceleration of the aqueous media in the static zone.

18. The process of claim 10, wherein a volumetric flow rate of the aqueous media through the static zone is no more than ⅓ of the volumetric flow rate through the first dynamic zone.

19. The process of claim 10, further comprising feeding the aqueous media to an inlet to a vessel comprising the first dynamic zone, the static zone and the second dynamic zone and discharging treated aqueous media from an outlet from the vessel.

20. The process of claim 19, further comprising recycling treated aqueous media to the inlet of the vessel.

21. The process of claim 20, further comprising adding a fluid super saturated with a gas to the treated aqueous media recycled to the inlet of the vessel.

22. The process of claim 10, further comprising adding a fluid super saturated with gas to the aqueous media upstream of the first dynamic zone.

23. The process of claim 10, further comprising detecting a level of cavitation and adjusting a speed of a first rotor and/or a second rotor in response to a detected level of cavitation in the aqueous media.

24. The process of claim 23, further comprising comparing the detected level of cavitation against a set point and adjusting the speed based on the comparison.

25. An apparatus for treating an aqueous media comprising organic constituents and microorganisms by causing cavitation in the aqueous media comprising:
a vessel comprising an inlet and an outlet, a first rotor and a second rotor, the second rotor spaced from the first rotor to define a static zone between the first rotor and the second rotor; and
a volume displaced by the second rotor in one revolution is greater than the volume displaced by the first rotor in one revolution.

26. The apparatus of claim 25, wherein volume of the vessel between the first rotor and the second rotor comprises at least three times the volume displaced by the first rotor in one revolution.

27. The apparatus of claim 25, wherein the first rotor is preceded by a plurality of rotors together comprising a first rotor assembly.

28. The apparatus of claim 25, wherein the second rotor is succeeded by a plurality of rotors together comprising a second rotor assembly.

29. The apparatus of claim 25, wherein the static zone is defined by a wall of non-metallic material.

30. The apparatus of claim 25, wherein one of the first rotor or the second rotor comprises an impeller.

31. The apparatus of claim 25, wherein the first rotor and/or the second rotor comprises a turbine.

32. The apparatus of claim 25, further comprising a sensor to detect a level of cavitation in the aqueous media and adjust a speed of the first rotor and/or the second rotor to a level of detection of cavitation in the aqueous media.

33. The apparatus of claim 32, further comprising comparing the detected level of cavitation against a set point and adjusting the speed based on the comparison.

34. The apparatus of claim 33, further comprising comparing the detected level of cavitation against a set point and adjusting the speed based on the comparison.

35. A process for treating an aqueous media comprising organic constituents and microorganisms by causing cavitation in the aqueous media comprising:
increasing a first velocity of the aqueous media in a first dynamic zone;
decreasing a second velocity of the aqueous media in a static zone; and
increasing a third velocity of the aqueous media in a second dynamic zone.

36. The process of claim 35 wherein a first potential volume displaced by the second dynamic zone is greater than the second potential volume displaced by the first dynamic zone.

37. The process of claim 36, wherein an increase in the first velocity results in an increase in angular momentum of components in the aqueous media.

38. The process of claim 36, wherein the second dynamic zone is downstream of the first dynamic zone.

39. The process of claim 36, wherein the static zone is downstream of the first dynamic zone.

40. The process of claim 36, further comprising increasing non-linear acceleration in the first dynamic zone.

41. The process of claim 40, further comprising increasing the non-linear acceleration of the aqueous media in the second dynamic zone.

42. The process of claim 40, further comprising revolving a rotor to impart angular momentum to components in the aqueous media.

43. The process of claim 36, further comprising decreasing a non-linear acceleration of the aqueous media in the static zone.

44. The process of claim 36, wherein a volumetric flow rate of the aqueous media through the static zone is no more than ⅓ of the volumetric flow rate through the first dynamic zone.

45. The process of claim 36, further comprising feeding the aqueous media to an inlet to a vessel comprising the first dynamic zone, the static zone and the second dynamic zone and discharging treated aqueous media from an outlet from the vessel.

46. The process of claim 45, further comprising recycling a treated aqueous media to the inlet to the vessel.

47. The process of claim 46, further comprising adding a fluid super saturated with gas to the treated aqueous media recycled to the inlet to the vessel.

48. The process of claim 36, further comprising adding a fluid super saturated with gas to the aqueous media upstream of the first dynamic zone.

49. The process of claim 36, further comprising detecting a level of cavitation and adjusting a speed of a first rotor and/or a second rotor in response to the detected level of cavitation in the aqueous media.

50. The process of claim 49, further comprising comparing the detected level of cavitation against a set point and adjusting the speed based on the comparison.
